(19) United States
(12) Patent Application Publication
(10) Pub. No.: US 2026/0192724 A1
(43) Pub. Date: Jul. 9, 2026

(54) HEADREST FOR A MOTOR VEHICLE SEAT

(71) Applicant: TREVES PRODUCTS,SERVICES & INNOVATION, Issy-Les-Moulineaux (FR)

(72) Inventors: Xavier BONFILS, Issy-Les-Moulineaux (FR); Eric BRILLON, Issy-Les-Moulineaux (FR); Arnaud DUVAL, Issy-Les-Moulineaux (FR)

(21) Appl. No.: 19/133,737

(22) PCT Filed: Nov. 30, 2023
(86) PCT No.: PCT/EP2023/083849

§ 371 Date: May 29, 2025

(30) Foreign Application Priority Data
Dec. 1, 2022 (FR) FR2212645

(51) Int. Cl. B60N 2/879; H04R 1/02; H04R 1/28; H04R 9/06

(52) U.S. Cl. CPC B60N 2/879; H04R 1/025; H04R 1/288; H04R 9/06; H04R 2499/13

(57) ABSTRACT

The invention relates to a headrest for a motor vehicle seat, said headrest comprising a support block (1) provided with a padding cushion (2) made of elastically compressible foam, said block being supported by a rigid frame (3) for mounting said headrest at the top of the backrest of said seat, said headrest being equipped with a generator of acoustic waves in the environment of said headrest, the generator comprising at least one plate (6) on which an electrodynamic transducer (7) is provided, said plate being attached to the support block (1) and being arranged to be excited vibrationally by said transducer in order to generate the acoustic waves, the support block (1) comprising a rear wall (14) which is covered with an acoustically insulating layer (16), the sealing of which to the airflow is sufficient to prevent the acoustic waves from passing through it.

The invention relates to a headrest for a motor vehicle seat, as well as to an assembly for generating acoustic waves in a motor vehicle passenger compartment comprising such a headrest.

It is known to equip a headrest with an acoustic wave generator allowing a sound signal to be emitted close to the head of an occupant of the seat on which the said headrest is mounted. The waves are then generated as close as possible to the user's ears in order to limit acoustic losses.

In addition to an audible signal, the generator can emit an “anti-noise” type sound signal, i.e. in phase opposition to the noise inside the passenger compartment, so as to enable active control of noise within said passenger compartment.

To achieve this, at least one loudspeaker can be integrated into the volume of the headrest. However, the size of a loudspeaker makes it difficult to fit into a piece of small size such as a headrest, and its weight makes the headrest fitted with it noticeably heavier.

In addition, the loudspeakers fitted to the headrests emit at medium and/or high frequencies but, for reasons of size, cannot emit at frequencies below 150 Hz, whereas these low frequencies, in particular frequencies of 100 Hz or even 60 Hz, are necessary for the quality of a sound signal, in particular of the “anti-noise” type.

Acoustic wave generators are known comprising a rigid plate which is excited vibrationally by an electrodynamic transducer in order to generate said waves. In this way, the transducer allows to transform an electrical control signal into an acoustic signal, by using the plate to which it is attached as a radiation surface.

Thanks to its compactness, this solution allows to reduce the space required for the acoustic wave generator to be integrated into a headrest, but generates a significant problem of transmission of vibrations to said headrest, which can be a source of discomfort in the environment around said headrest, particularly for the passenger seated on the seat equipped with it.

The aim of the invention is to propose a headrest that can overcome these drawbacks, in particular the transmission of vibrations to the rear of the headrest, which could generate a sound signal that disturbs passengers seated behind the seat on which the said headrest is mounted.

To this end, according to a first aspect, the invention proposes a headrest for a motor vehicle seat, said headrest comprising a support block provided with a padding cushion made of elastically compressible foam, said block being supported by a rigid frame for mounting said headrest at the top of the backrest of said seat, said headrest being equipped with a generator of acoustic waves in the environment of said headrest, the generator comprising at least one plate on which an electrodynamic transducer is provided, said plate being attached to the support block and arranged to be excited vibrationally by said transducer in order to generate the acoustic waves, the support block comprising a rear wall which is covered with an acoustically insulating layer, the sealing of which to the airflow is sufficient to prevent the acoustic waves from passing through it.

According to a second aspect, the invention proposes an assembly for generating acoustic waves in a motor vehicle passenger compartment, said assembly comprising such a headrest and a system for controlling at least one transducer to excite vibrationally the plate on which it is associated.

Further features and advantages of the invention will become apparent from the following description, made with reference to the appended figures, in which:

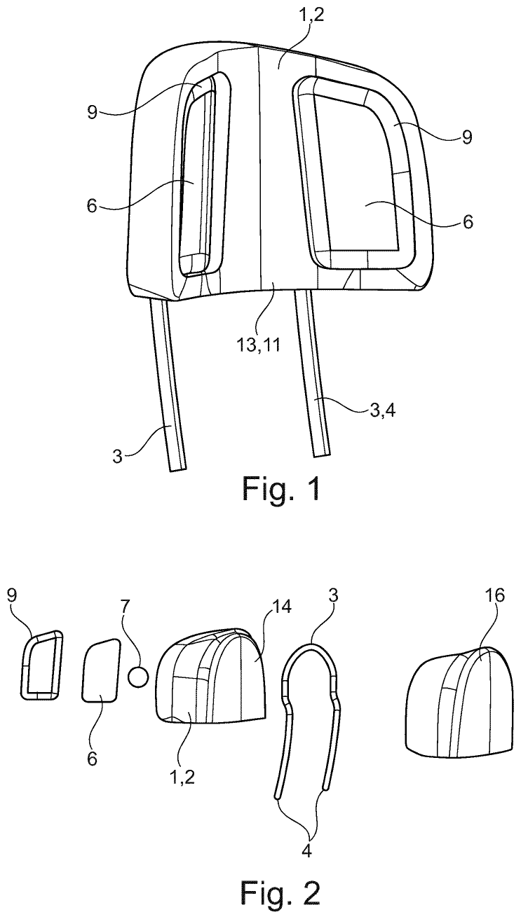

FIG. 1 is a schematic perspective front view of a headrest according to one embodiment of the invention;

FIG. 2 is a schematic perspective exploded rear view of the headrest shown in FIG. 1;

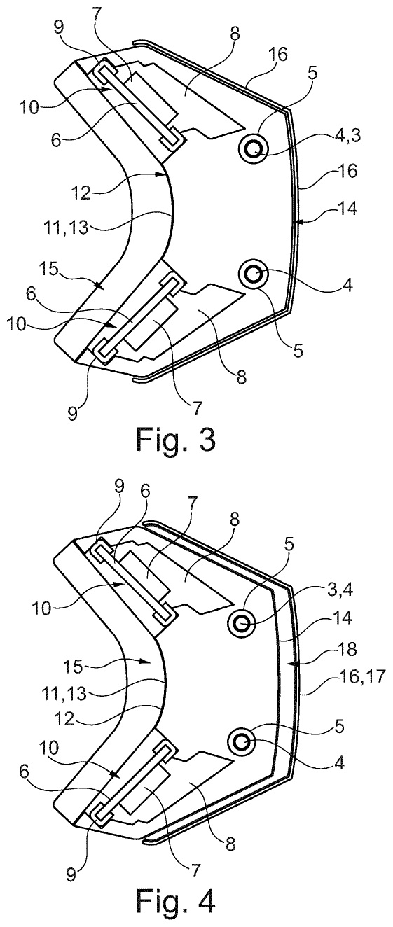

FIG. 3 and FIG. 4 are schematic horizontal cross-sections views of the headrest shown in FIG. 1, according to a respective embodiment of the invention.

In connection with these figures, a headrest for a motor vehicle seat is described below, as well as an assembly for generating acoustic waves in a motor vehicle passenger compartment which includes such a headrest.

In this description, the terms of positioning in space (lateral, transverse, top, rear, . . . ) are taken to refer to the headrest positioned in the vehicle in the situation of use.

The headrest comprises a support block 1 provided with a padding cushion 2 made of elastically compressible foam, said block being supported by a rigid frame 3 for mounting said headrest at the top of the backrest of a motor vehicle seat (not shown).

The rigid frame 3 may comprise at least one rod 4, in particular of metallic material, which is fitted into a duct 5 formed in the support block 1.

In particular, the support block 1 can comprise a housing, in particular made of molded plastic material, which absorbs energy in the event of an occupant's head impact, which is surrounded by the padding cushion 2, the duct 5 being formed in said housing.

In the embodiments shown, the rigid frame 3 has an inverted U-shaped geometry, the branches of which form two rods 4 which are each fitted in a respective duct 5 formed in the support block 1.

The cushion 2 can take the form of a block of molded skin foam, with the skin on the outside, said foam having a hardness greater than 25 shore A, and in particular of the order of 30 shore A.

The foam of the support block 1 can also have a density of between 0.20 and 0.30, and in particular of the order of 0.25.

The headrest is equipped with a generator of acoustic waves in the environment of said headrest, the generator comprising at least one plate 6 on which an electrodynamic transducer 7 is provided.

The plate 6 is attached to the support block 1 and arranged to be excited vibrationally by the transducer 7, in order to generate the acoustic waves. The assembly for generating acoustic waves in the passenger compartment includes a system for controlling the transducer 7 to excite vibrationally the plate 6 on which it is provided.

In the embodiment shown, the headrest comprises two generators arranged laterally on either side of the support block 1, each comprising a transducer 7 provided on a respective plate 6 to excite it vibrationally, so as to generate acoustic waves on either side of the head of a seat occupant.

In addition, the control system is arranged to drive each of the two transducers 7, either jointly or independently.

The padding cushion 2 is provided with two cavities 8 arranged laterally on either side of the support block 1, and in each of which a plate 6 is attached by its periphery to said padding cushion.

In particular, each cavity 8 has an aperture 10 opening into a front wall 11 of the support block 1 opposite which the occupant's head is intended to come, the plate 6 being mounted in said aperture.

The plates 6 each have a Young's modulus E greater than 10 MPa, in particular of between 100 MPa and 1 GPa, so as to provide sufficient rigidity to generate acoustic waves without deformation when excited vibrationally by their transducer 7.

To prevent the transmission of vibrations generated by the plate 6, the headrest comprises a vibration decoupling means arranged between said plate and said support block.

In particular, the vibration decoupling means comprises two seals 9 made of elastomer material, each of which is interposed between a respective plate 6 and the padding cushion 2, each surrounding the periphery of said plate.

In a variant not shown, the headrest can also include a vibration decoupling means arranged between the support block 1 and the rigid frame 3, in particular in the form of sleeves made of elastomer material each interposed between a rod 4 and its mounting duct 5 in said support block, in order to avoid propagation of vibrations at the level of the mounting of said support block on said frame, and thus avoid propagation of said vibrations from said frame to the backrest of the seat.

The decoupling means 9 comprises an elastomer material with a Young's modulus E of less than 20 kPa, so as to provide sufficient flexibility to decouple the vibratory plate 6 from the support block 1, and possibly to decouple said support block from the frame 3. In particular, the high flexibility of the material allows particularly effective vibratory decoupling at low frequencies, especially below 150 Hz, or even 100 Hz and up to 60 Hz.

In addition, the flexibility of the elastomer material is adapted to allow the decoupling means 9 to withstand the mechanical stresses required for the headrest in the event of the seat occupant's head impacting on it.

The elastomer material is preferably foam-based, in particular polyurethane (PU) foam or EPDM (ethylene propylene diene monomer) foam rubber.

In addition, the elastomer material of the decoupling means 9 has an ETA loss factor greater than 0.2 to optimize its decoupling function.

Advantageously, the foam of the cushion 2 is flexible enough to contribute to vibration decoupling between the support block 1 and the plates 6, while at the same time being sufficiently rigid to ensure the holding of said plates in their respective cavities 8. In particular, the foam of the cushion 2 has a Young's modulus E greater than 20 kPa, allowing vibration decoupling at medium and high frequencies.

To prevent the transmission of vibrations from the support block 1 to the head of the seat occupant, said block comprises a support layer 12 which is arranged on at least a part of the front wall 11 opposite which said head is intended to come, said support layer having a Young's modulus of less than 40 kPa.

In this way, the support layer 12 allows to provide the support block 1 with greater flexibility in the area facing the occupant's head, so as to provide localized acoustic decoupling, while retaining greater rigidity in the other areas of the cushion 2, so as to maintain the stresses associated with holding the plates 6 in place and absorbing shocks.

The support layer 12 also has a resistivity to the passage of air of less than 5,000 N.m⁻⁴.s, in order to allow the passage through it of the acoustic waves generated by the vibration of the plates 6, and thus to allow said waves to reach the occupant's ears with preserved quality. The support layer 12 thus forms a solid-state insulating barrier, with both acoustic insulating and damping properties.

In one embodiment, the support layer 12 is formed from a membrane-free, very open-cell foam, in particular with cells of diameter greater than 1 mm, and more particularly of between 2 and 3 mm. This foam may, for example, be of the same type as the foams generally used for wind protection of microphones (so-called “pop-up” foams).

In the embodiments shown, the apertures 10 of the cavities 8 are separated by a central area 13 of the front wall 11, and the support layer 12 covers at least each of these apertures 10 and said central area. Advantageously, the support layer 12 extends over the entire front wall 11, thereby enhancing the comfort of the seat occupant.

In addition, the support block 1 is fitted with an appearance layer 15 under which the support layer 12 is arranged, which allows to improve the aesthetic appearance of the headrest while protecting said support layer.

To prevent acoustic waves from propagating to the rear of the headrest, and thus not disturbing any passengers at the rear of the passenger compartment, the support block 1 comprises a rear wall 14 which is covered with an acoustically insulating layer 16, the sealing of which to the airflow is sufficient to prevent the acoustic waves from passing through said insulating layer.

Advantageously, the acoustically insulating layer 16 has a mass per unit area of between 400 g/m² and 2 kg/m², providing a good compromise between insulation and the weight of said layer.

According to a first embodiment (FIG. 3), the acoustically insulating layer 16 has a Young's modulus of less than 500 MPa, in order to give said insulating layer a flexibility which is sufficient to allow it also to have damping properties, and thus to prevent the propagation to the rear of the headrest of vibrations generated by the plates 6.

In this case, the insulating layer 16 acts as a solid-state insulating barrier, with both acoustic insulating and damping properties.

Furthermore, in this first embodiment, the support block 1 can be fitted with a textile-based rear appearance layer (not shown), the acoustically insulating layer 16 being arranged under said rear appearance layer, in order to improve the aesthetic appearance of the headrest and to conceal and/or protect said insulating layer.

In a second embodiment (FIG. 2), the support block 1 has a rear appearance shell 17 made of a rigid material, in particular thermoplastic material, said shell forming the acoustically insulating layer 16.

In this second embodiment, the insulating layer 16 has in particular a Young's modulus greater than 500 MPa, which makes it too rigid to provide it with damping properties. Thus, this rigid layer 16 is combined with a vibration decoupling layer 18 to form a barrier against the propagation of vibrations to the rear of the headrest.

In particular, the vibration decoupling layer 18 is arranged under the insulating shell 16, 17, so as to be protected and/or concealed by it while improving the aesthetic appearance of the headrest.

The vibration decoupling layer 18 is based on an elastomer material with a Young's modulus of less than 40 kPa, so as to provide sufficient flexibility to ensure its function of damping vibrations originating from the plates 6 and propagated to the support block 1.

The elastomer material of this layer 18 is preferably foam-based, in particular polyurethane foam (PU) or EPDM (ethylene-propylene-diene monomer) rubber foam. Furthermore, this elastomer material has an ETA loss factor which is greater than 0.25.

1. A headrest for a motor vehicle seat, said headrest comprising a support block (1) provided with a padding cushion (2) made of elastically compressible foam, said block being supported by a rigid frame (3) for mounting said headrest at the top of the backrest of said seat, said headrest being equipped with a generator of acoustic waves in the environment of said headrest, said headrest being characterized in that the generator comprises at least one plate (6) on which an electrodynamic transducer (7) is provided, said plate being attached to the support block (1) and being arranged to be excited vibrationally by said transducer in order to generate the acoustic waves, the support block (1) comprising a rear wall (14) which is covered with an acoustically insulating layer (16), the sealing of which to the airflow is sufficient to prevent the acoustic waves from passing through it.

2. Headrest as claimed in claim 1, characterized in that the acoustically insulating layer (16) has a Young's modulus E of less than 500 MPa.

3. Headrest according to claim 1, characterized in that the support block (1) is fitted with a textile-based appearance layer, the acoustically insulating layer (16) being arranged under said appearance layer.

4. Headrest according to claim 1, characterized in that the acoustically insulating layer (16) has a Young's modulus E greater than 500 MPa, said layer being associated with a vibration decoupling layer (18).

5. Headrest according to claim 4, characterized in that the vibration decoupling layer (18) is based on an elastomer material with a Young's modulus E of less than 40 kPa.

6. Headrest according to claim 4, characterized in that the vibration decoupling layer (18) is based on an elastomer material with an ETA loss factor greater than 0.25.

7. Headrest according to claim 4, characterized in that the support block (1) has an appearance rear shell (17), said shell forming the acoustically insulating layer (16) under which the vibration decoupling layer is arranged.

8. Headrest according to claim 1, characterized in that the acoustically insulating layer (16) has a mass per unit area of between 400 g/m² and 2 kg/m².

9. Headrest according to claim 1, characterized in that the support block (1) is provided with at least one cavity (8) in which the plate (6) is attached, said cavity having an aperture (10) opening into a front wall (11) of said block.

10. Headrest according to claim 1, characterized in that the plate (6) has a Young's modulus E which is greater than 10 MPa.

11. An assembly for generating acoustic waves in a motor vehicle passenger compartment, said assembly comprising a headrest according to claim 1, and a system for controlling at least one transducer (7) to excite vibrationally the plate (6) on which it is provided.
